(19) United States
(12) Patent Application Publication
(10) Pub. No.: US 2012/0081533 A1
(43) Pub. Date: Apr. 5, 2012

(54) REAL-TIME EMBEDDED VISION-BASED EYE POSITION DETECTION

(75) Inventors: Wensheng Fan, Plano, TX (US); WeiYi Tang, Plano, TX (US)

(73) Assignee: VisionBrite Technologies Inc., Plano, TX (US)

(21) Appl. No.: 12/898,146

(22) Filed: Oct. 5, 2010

(51) Int. Cl. H04N 7/18; G06K 9/00; G06K 9/46

(52) U.S. Cl. 348/78; 382/190; 382/167; 348/E07.085

(57) ABSTRACT

One aspect provides an image capture device which, in one embodiment, includes a camera, image processor, and interface. The image processor is configured to determine a location of at least one eye of a presenter in a captured image captured by the camera. The image processor is also configured to cause a projection control processor external to the image capture device to modify a corresponding location of a projectable image.

### TECHNICAL FIELD

This application is directed, in general, to image processing and machine vision and, more specifically, to an image capture device and a method of determining a position of eyes of a presenter in a monitored field of view.

### BACKGROUND

Evolving projector technology, computing power, and easy-to-use software have enabled individuals to provide impactful presentations more cost effectively than ever. It is now common to see presentations in meetings where a presenter only need a laptop computer, presentation software, and a compact projector all of which are available today at attractive costs. However, a problem remains for a presenter making a presentation using today's cost-effective hardware/software solutions. That is, standing in front of a projector blinds the presenter, not allowing the presenter to see an audience while speaking. Also, when moving out of the bright light of the projector, the presenter's eyes must acclimate to a darker environment, distracting the presenter.

### SUMMARY

One aspect provides an image capture device. In one embodiment, the image capture device includes a camera, an image processor, and an interface. The image processor is configured to determine a location of at least one eye of a presenter in a captured image captured by the camera. The image processor is also configured to cause a projection control processor external to the image capture device to modify a corresponding location of a projectable image.

In another embodiment, the image capture device includes a camera, an image processor, a storage device, and an interface. The camera is configured to a presence of an object, typically a presenter, in a monitored field of view. Once a presence has been detected in the monitored field of view, the image capture device is configured to capture an image of the presence. The image processor is further configured to determine an approximate head shape in the image and match a best one of a plurality of pre-defined head shapes with the approximated head shape determined in the region of interest. Based on the matched best shape, the image processor is further configured to determine an eye box bounding a position of where eyes would be in the matched best shape. The interface is configured to transmit a size and-position of the eye box to a projection control processor external to the image capture device.

Another aspect provides a method. In one embodiment, the method comprises determining, by an image processor of an image capture device, a location of at least one eye of a presenter in a captured image captured by a camera of the image capture device. The method also comprises modifying a corresponding location of a projectable image by a projection control processor external to the image capture device.

In another embodiment, the method comprises detecting a presence of an object, typically a presenter, with a camera of an image capture device in a bottom portion of a monitored field of view. Once a presence has been detected in the bottom portion of the field of view, the method further comprises capturing an image of the presence by the camera. The method continues by determining an approximate head shape in the image and matching, by the image processor, a best one of a plurality of pre-defined head shapes with the approximated head shape determined in the region of interest, where the matched best shape represents a face of the presenter. Based on the matched best shape, the method further comprises determining, by the image processor, an eye box bounding a position of where eyes would be on the matched best shape and transmitting, by an interface of the image capture device, a size and position of the eye box to a projection control processor external to the image capture device.

Yet another aspect provides a real-time embedded vision-based eye position detection system. In one embodiment, the system comprises a projection control processor and an image capture device. The image capture device includes a camera, an image processor, and an interface. The image processor is configured to determine a location of at least one eye of a presenter in a captured image captured by a camera of the image capture device. The image processor is also configured to cause the projection control processor external to the image capture device to modify a corresponding location of a projectable image.

In another embodiment, the system comprises a projection control processor and an image capture device. The image capture device includes a camera, an image processor, a storage device, and an interface. The camera is configured to detect a presence of a presenter in a monitored field of view. Once the presence has been detected in the monitored field of view, the image capture device is configured to capture an image of the presence. The image processor is further configured to determine an approximate head shape in the image and match a best one of a plurality of pre-defined head shapes with the approximated head shape determined in the region of interest where the matched best shape represents a face of the presenter. Based on the matched best shape, the image processor is further configured to determine an eye box bounding a position of where eyes would be in the matched best shape. The interface is configured to transmit a size and position of the eye box to the projection control processor external to the image capture device.

### BRIEF DESCRIPTION OF THE DRAWINGS

Reference is now made to the following descriptions taken in conjunction with the accompanying drawings, in which:

FIG. 1 illustrates a block diagram of an embodiment of an image capture device;

FIG. 2 illustrates an embodiment of an object in a monitored field of view;

FIG. 3 illustrates an embodiment of an eye box of a matched best one of a plurality of pre-defined oval shapes;

FIG. 4 illustrates a block diagram of an embodiment of a real-time embedded vision-based eye position detection system;

FIG. 5 illustrates a block diagram of another embodiment of a real-time embedded vision-based eye position detection system; and

FIG. 6 illustrates a flow diagram of an embodiment of a method of an image capture device.

### DETAILED DESCRIPTION

As stated above, standing in front of a projector blinds the presenter, not allowing the presenter to see an audience while speaking. Also, when moving out of the bright light of the projector, the presenter's eyes must acclimate to a darker environment, distracting the presenter. What is needed is a way to shield the presenter's eyes from the bright light of the projector. However, what is needed is a way to shield the presenter's eyes that does not require the presenter to wear sunglasses. More specifically, what is needed is a way to alter projected images so that the bright light of the projector is not directed to the eyes of the presenter.

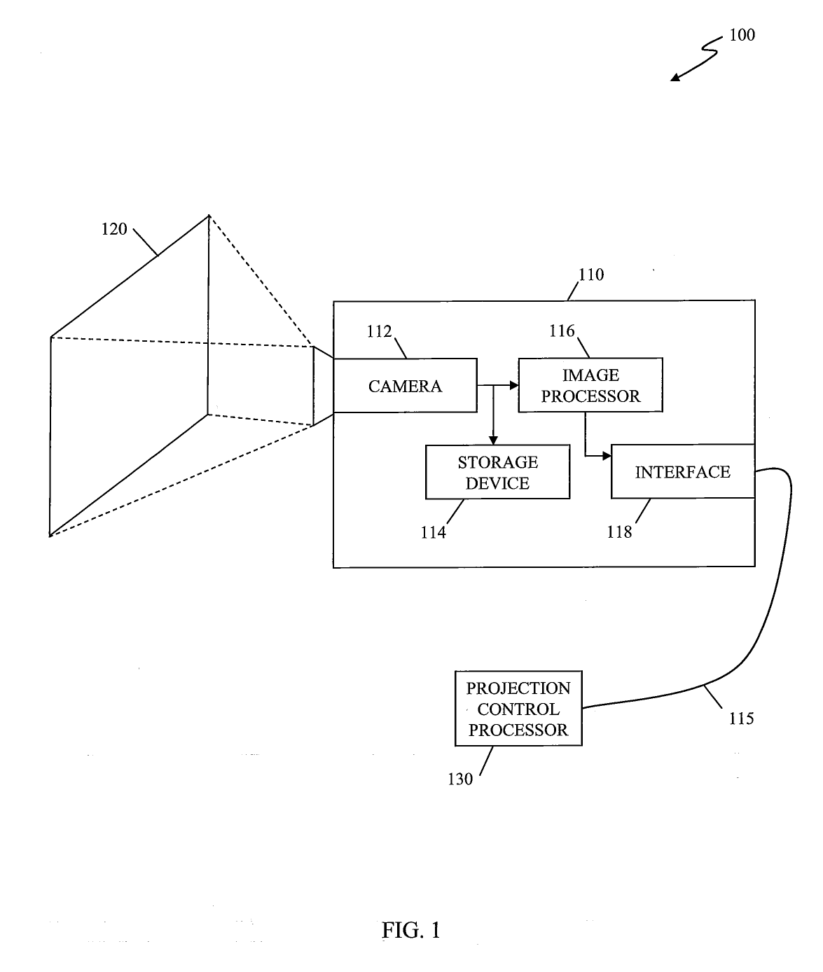

FIG. 1 illustrates an embodiment 100 of an image capture device 110 constructed according to the principles of the invention. The image capture device 110 includes a camera 112, a storage device 114, an image processor 116, and an interface 118. The camera 112 captures a captured image in a field of view 120. The camera 112 couples to the storage device 114 and the image processor 116. In the illustrated embodiment, captured images captured by the camera 112 are stored in the storage device 112 in a conventional manner and format. Alternative embodiments employ various manners and formats. The interface 118 is coupled to the image processor 116. The interface 118 also is operatively connected, through a link 115, to a projection control processor 130 that is external to the image capture device 110. The link 115 and the interface 118 support one or more conventional or future standard wireline and wireless communication formats such as, e.g., USB, RS-232, RS-422, or Bluetooth®. The operation of various embodiments of the image capture device 110 will now be described. In other embodiments of the image capture device 110, an external conventional camera could be used in place of the camera 112 of the embodiment of FIG. 1. The external conventional camera could communicate with the image capture device using conventional standards and formats, such as, but not limited to, e.g., USB, RS-232, RS-422, or Bluetooth®.

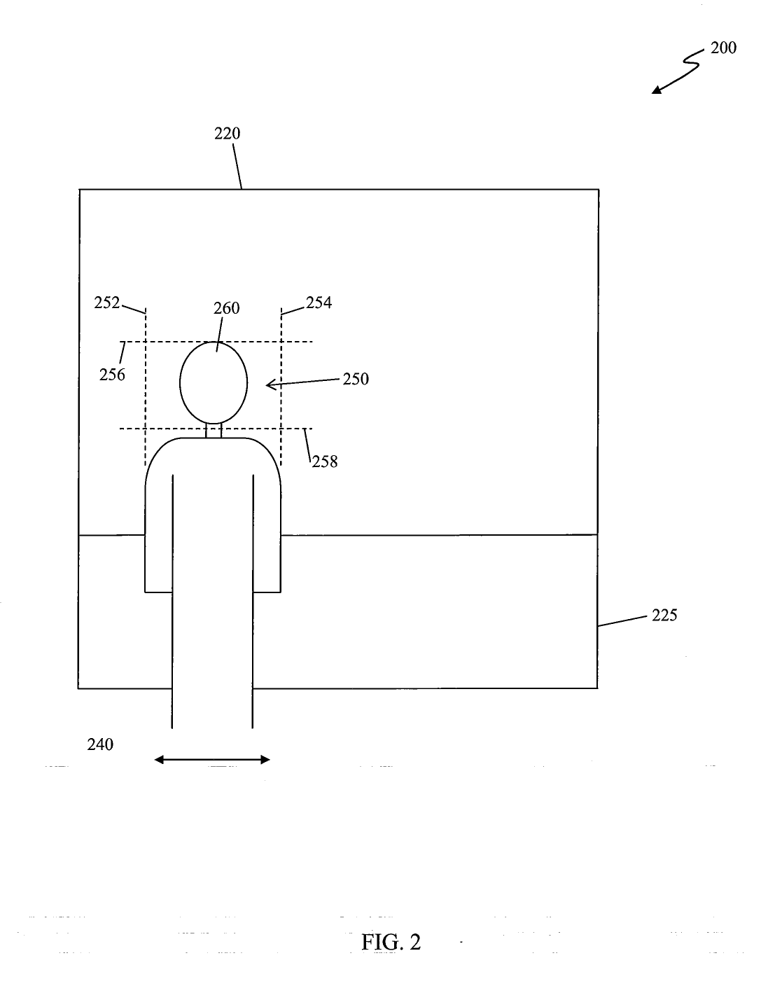

FIG. 2 illustrates an embodiment 200 of a monitored field of view 220, similar to the field of view 120 of FIG. 1. FIG. 2 shows a bottom portion 225 of the field of view 220. Upon power-up of the image capture device 110, the camera 112 and the image processor 116 of the image capture device 110 of FIG. 1 monitor a portion of the field of view 220 (e.g., the bottom portion 225), e.g., using conventional techniques to detect an initial presence of an object 240, typically a presenter, in the bottom portion 225. Alternative embodiments detect the object 240 in other portions of the field of view 220.

When an initial presence of the object 240 is detected in the bottom portion 225, the camera 112 and the image processor 116 capture a captured image of the field of view 220. The image processor 116 determines a left 252 and right 254 edge f the captured image, e.g., using conventional techniques. Then, the image processor 116 also determines a top edge 256 of the object 240 in the captured image, again using conventional techniques. The image processor 116 then uses the left 252, right 254, and top 256 edges of the object 240 to start a determination of a region of interest 250. The determination of region of interest 250 is completed by the image processor 116 calculating a bottom edge 258 of the region of interest 250 by offsetting a pre-defined distance below the top edge 256. Alternative embodiments determine or calculate other edges of the captured image or the object 240 to yield the region of interest 250.

Once the region of interest 250 has been determined, the image processor 116 of the image capture device 110 approximates a head, or oval, shape 260 in the region of interest 250 of the captured image. The image processor then compares the approximated head shape 260 with a plurality of pre-defined head shapes to find a best match. The plurality of pre-defined head shapes could be stored, e.g., in any conventional storage device such as, e.g., the storage device 114 of image capture device 110 or a memory of the image processor 116 of the image capture device 110.

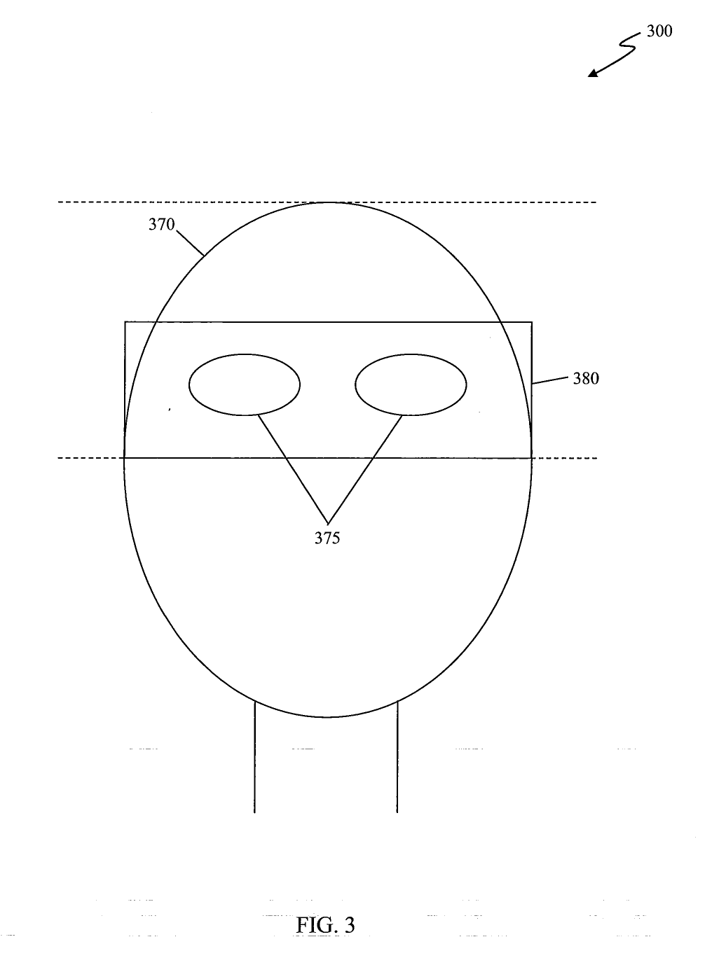

FIG. 3 illustrates an embodiment 300 of a matched best shape 370. The image processor 116 uses the matched best shape 370 to generate an eye box 380 bounding a position of where at least one of the eyes 375 would be on the matched best shape. In some embodiments, a lower edge of the eye box 380 could be a horizontal line at a center of the matched best shape 370. In these embodiments, a top edge of the eye box 380 could be half the distance from the horizontal line at the center of the matched best shape 370 to a top edge of the matched best shape 370. Further, a left and right edge of the eye box 380 could be a left and right edge of the matched best shape 370. Alternative embodiments determine the eye box 380 in other ways.

Once the eye box 380 is determined by the image processor 116 of the image capture device 110, interface 118 of image capture device 110 (coupled to the image processor 116) can then transmit a size and position of the eye box 380 to the projection control processor 130 of FIG. 1 through the link 115. The projection control processor 130 then associates the size and position of the eye box 380 with a projectable image the projection control processor 130 causes to be displayed in the monitored field of view 120/220. Once the projection control processor 130 associates the size and position of the eye box 380 with the projectable image to be displayed in the monitored field of view 120/220, the projection control processor 130 then modifies the projectable image to be displayed by changing an intensity of light in a portion of the projectable image associated with the eye box 380. In this embodiment, the intensity of light in the portion of the projectable image associated with the eye box 380 can be reduced to zero, effectively blacking out the portion of the projectable image associated with the eye box 380. In an alternative embodiment, the projection control processor 130 modifies the projectable image to be displayed by changing the color of the portion of the projectable image associated with the eye box 380 to one or more other colors, such as dark gray, rather than blacking out the portion.

In alternative embodiments, rather than transmitting a size and position of eye box 380 to the projection control processor 130, the image capture device 110 transmits a size and position of either the approximated head shape 260 detected in the region of interest 250 or the matched best shape 370. In these embodiments, the projection control processor 130 modifies the projectable image by either changing the intensity or color of light in a portion of the projectable image associated with either the approximated head shape 260 or matched best shape 370 rather than the eye box 380. In some of these alternative embodiments, the projection control processor 130 modifies the projectable image by increasing the intensity of light in the portion of the projectable image associated with either the approximated head shape 260 or matched best shape 370. In these embodiments, the portion of the projectable image modified with increased light could be slightly larger than the approximated head shape 260 or matched best shape 370, effectively creating a follow spot, or spot light on the presenters head as the presenter moves within the monitored field of view 120/220. Also, in these embodiments, the projectable image may be modified so that only the follow spot is projected. In yet other alternative embodiments, the portion of the projectable image modified by the projection control processor 130 may be any shape based on the size and position of either the eye box 380 or matched best shape 370. In these embodiments, the portion of the projectable image could be offset relative to the corresponding position of either the eye box 380 or matched best shape 370.

Returning to the embodiment in FIG. 2, the image processor 116 of the image capture device 110, continues, once the initial presence described above has been detected, to monitor the bottom portion 225 for any differences from the captured image that may occur over time (typically resulting from movement of the object 240). If there are no differences from the captured image, the same eye box 380 size and position are retransmitted to the projection control processor 130 signifying that the object 240 remains stationary. This way, image processor 116 and image capture device 110 do no processing, other than monitoring, until the object 240 enters the bottom portion 225 of the field of view 220 and also when there is no movement in the field of view 220 (i.e., no difference from the originally captured image). If, however, there is a difference from the captured image, a new captured image is captured and a new eye box 380 size and position are generated and transmitted to projection control processor 130 as described above. In this case, the difference from the originally captured image signifies that the object 240 is moving as denoted by the double-arrow line in FIG. 2.

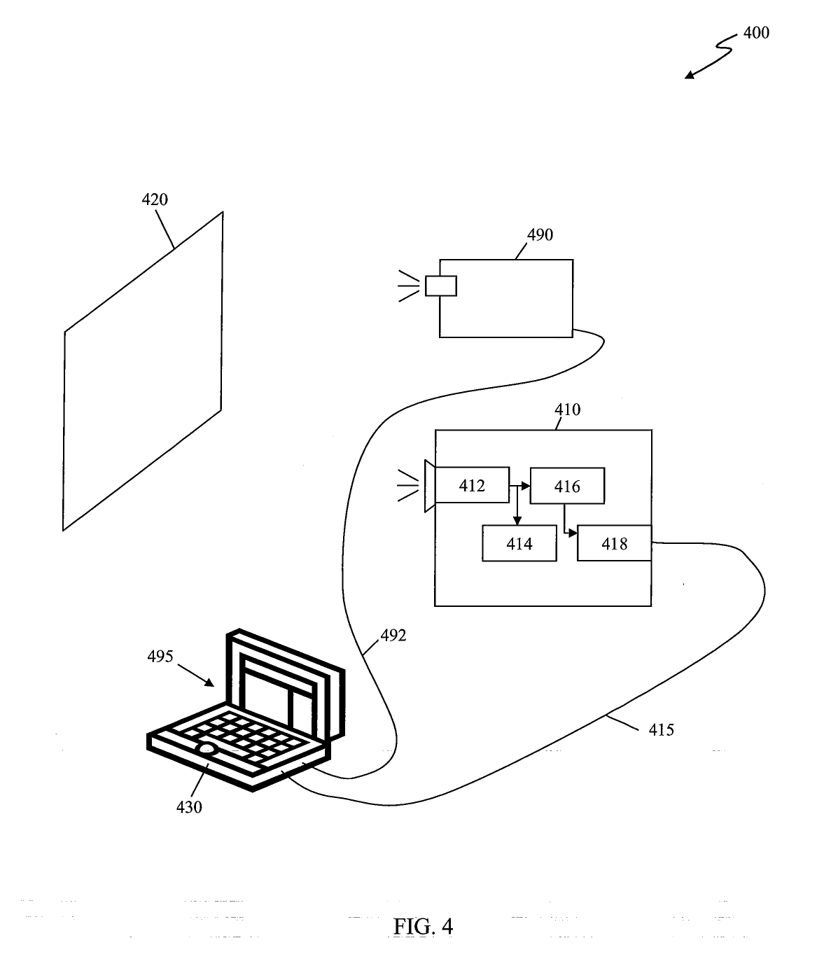

FIG. 4 illustrates an example of embodiment 400 of a real-time embedded vision-based eye position detection system in accordance with the principles of the invention. A presenter (not shown) prepares a presentation on a computer 495 using conventional presentation software, such as PowerPoint®, which is commercially available from Microsoft® Corporation of Redmond, Wash. The computer 495 includes a projection control processor 430. The computer 495 is operatively coupled to an image capture device 410 through a link 415 in a manner as described above. The image capture device 410 monitors a field of view 420 with a camera 412 and an image processor 416 as described above. The projection control processor 430 of computer 495 associates a size and position of the eye box 380 determined by the image capture device 410 as described above. The projection control processor 430 then modifies a projectable image caused to be displayed by the projection control processor 430 in the monitored field of view 420 by blacking out a portion of the projectable image associated with the eye box 380 or by changing the portion of the image associated with the eye box 380 to one or more darker colors. A projector 490 is operatively coupled through link 492 to the computer 495 and displays the modified projectable image to the monitored field of view 420. The illustrated embodiment of the link 492 supports one or more known and future standard wired and wireless communication formats such as, e.g., USB, RS-232, RS-422, or Bluetooth®. As the presenter moves in the monitored field of view 420, the image capture device 410 continuously redefines the region of interest 250 of FIG. 2 and transmits new sizes and positions of the eye box 380 to the projection control processor which modifies the projectable image caused to be displayed on a real-time basis as described above. Thus, since the detection of size and position of the eye box 380 are embedded in the image capture device 410, FIG. 4 illustrates an embodiment of a real-time embedded vision-based eye position detection system.

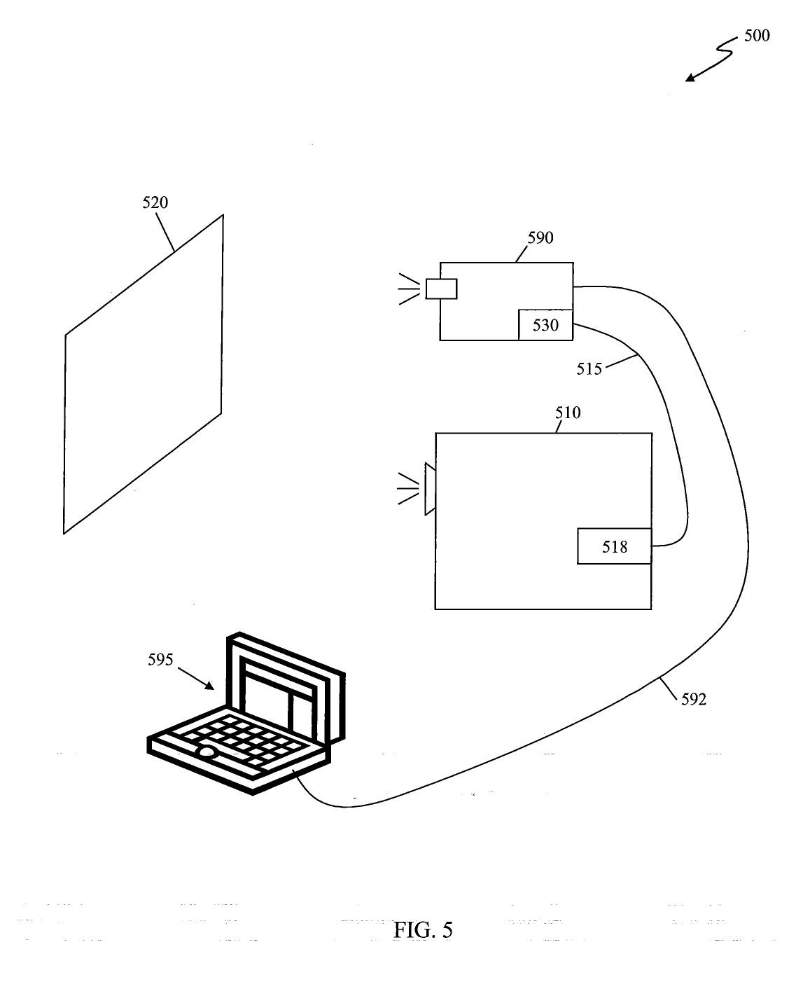

In contrast to the embodiment illustrated in FIG. 4, the embodiment 500 of a real-time embedded vision-based eye detection system illustrated in FIG. 5 depicts a projection control processor 530 included in a projector 590 rather than a computer 595. In this embodiment, the presenter again creates a presentation using conventional presentation software on the computer 595. The computer 595 is operatively coupled to the projector 590 through link 592. Links 515, 592, as with links 415, 492 of FIG. 4, support one or more known and future standard wired and wireless communication formats such as, e.g., USB, RS-232, RS-422, or Bluetooth®. The projection control processor 530 of the projector 590 modifies a projectable image caused to be displayed by the computer 595 by blacking out a portion of the projectable image associated with the eye box 380 created by the image capture device 510 and transmitted by an interface 518 over the link 515 to the projection control processor 530 of the projector 590 as described above. Then the projection control processor 530 causes the projector 590 to display the modified projectable image in the monitored field of view 520. In some embodiments, the projector 590 may have a switch accessible to the presenter (not shown) that allows to the presenter to enable or disable modifying the image the computer 595 causes to be displayed to include eye box 380.

In alternative embodiments, both the projection control processor 430/530 and the image capture device 410/510 are included in the projector 490/590 or the computer 495/595.

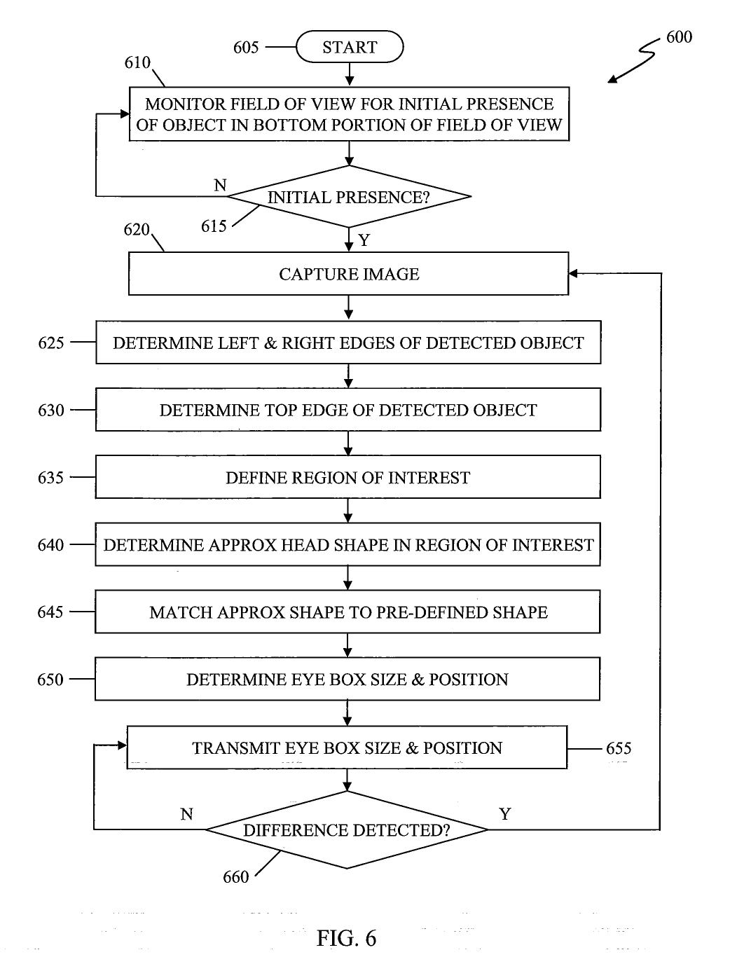

FIG. 6 illustrates an embodiment 600 of a method the image capture devices 110, 410, 510 of FIGS. 1, 5, and 6, respectively, may use to determine a size and position of an eye box to a projection control processor external to the image capture device. The method begins at a step 605.

In a step 610 a field of view is monitored by a camera of an image capture device for an initial presence of an object, such as a presenter, in a bottom portion of the field of view. If an initial presence of the presenter is not determined in a step 615, the method returns to step 610 to continue to monitor for an initial presence of the presenter. If, in step 615, the initial presence of the presenter is detected, the method continues to a step 620 where a captured image of the presenter is captured by a camera and image processor of the image capture device. The method continues to a step 625 where the image processor of the image capture device determines a left and right edge of the presenter in the captured image. Alternative embodiments detect the presenter in other portions of the field of view 220.

In a step 630, the image processor determines a top edge of the presenter in the captured image. Next, in a step 635, the image processor defines a region of -interest of the captured image. The left, right, and top edges of the region of interest are the left and right edges determined in the step 625 and the top edge determined in the step 630. In the step 635, the image processor defines a bottom edge of the region interest as a pre-defined distance below the top edge. In a step 640, the image processor determines an approximate head, or oval, shape in the region of interest. Alternative embodiments determine or calculate other edges of the captured image or the presenter object to yield the region of interest.

The method continues in a step 645 where the image processor matches a best one of a plurality of pre-defined head shapes with the approximate head shape determined in the step 640. The best one of the plurality of pre-defined head shapes represents a face of the presenter. Once the best one of the plurality of pre-defined head shapes is matched in the step 645, the image processor determines an eye box bounding a position of where eyes would be on the matched best shape in a step 650. Once the eye box is determined in the step 650, an interface of the image capture device transmits a size and position of the eye box to a projection control processor external to the image capture device in a step 655.

The method continues as the image processor and camera of the image capture device continuously and in real time monitors the field of view for any change from the originally captured image. If there is no change from the originally captured image, the method returns to step 655 and the same eye box size and position is retransmitted to the external projection control processor. If, however, there is a change from the originally captured image, signifying movement of the presenter in the field of view, the method returns to step 620 where a new captured image is captured and, as described above, a new eye box size and position is then transmitted to the external projection control processor. With this embodiment of the method, the image control processor is not required to do any processing until an initial presence of a presenter is detected or the presenter moves in the field of view. Furthermore, the method provides for altering a projectable image to be projected by blacking out the projectable image where the eyes of the presenter are, even when the presenter moves in the field of view.

Certain embodiments of the invention further relate to computer storage products with a computer-medium that have program code thereon for performing various computer-implemented operations that embody the eye detection systems or carry out the steps of the method set forth herein. The media and program code may be those specially designed and constructed for the purposes of the invention, or they may be of the kind well known and available to those having skill in the computer software arts. Examples of computer-readable media include, but are not limited to: magnetic media such as hard disks, floppy disks and magnetic tape; optical media such as CD-ROM disks; magneto-optical media such as optical disks; and hardware devices that are specifically configured to store and execute program code, such as ROM and RAM devices. Examples of program code include both machine code, such as produced by a compiler and files containing higher level code that may be executed by the computer using an interpreter.

Those skilled in the art to which this application relates will appreciate that other and further additions, deletions, substitutions and modifications may be made to the described embodiments.

What is claimed is:

1. An image capture device, comprising:
a camera;
an image processor; and
an interface;
wherein said image processor is configured to:
determine a location of at least one eye of a presenter in a captured image captured by said camera; and
cause a projection control processor external to said image capture device to modify a corresponding location of a projectable image.

2. The image capture device as recited in claim 1, wherein said image capture device is configured to cause said external projection control processor to change an intensity or color of light in said corresponding location of said projectable image.

3. The image capture device as recited in claim 1, wherein said image capture device is configured to detect movement of said presenter if a difference from said captured image is detected.

4. The image capture device as recited in claim 1, wherein said image capture device is configured to approximate a head shape of said presenter in said captured image an match a best one of a plurality of pre-defined head shapes with said approximated head shape.

5. The image capture device as recited in claim 4, wherein said image capture device is further configured to define an eye box bounding a position where said at least one eye would be on said best one of said plurality of pre-defined shapes.

6. The image capture device as recited in claim 5, wherein said image capture device is further configured to transmit, by said interface, a size and position of said eye box to said external projection control processor.

7. The image capture device as recited in claim 1, wherein a computer external to said image capture device includes said external projection processor.

8. The image capture device as recited in claim 7, wherein said computer is operatively connected to a projector configured to display said modified projectable image.

9. The image capture device as recited in claim 1, wherein a projector external to said image capture device includes said external projection control processor, said projector configured to display said modified projectable image.

10. A method, comprising:
determining, by an image processor of an image capture device, a location of at least one eye of a presenter in a captured image captured by a camera of said image capture device; and
modifying a corresponding location of a projectable image by a projection control processor external to said image capture device.

11. The method as recited in claim 10, wherein said modifying changes an intensity or color of light in said corresponding location of said projectable image.

12. The method as recited in claim 10, further comprising detecting movement of said presenter, by said image capture device, if a difference from said captured image is detected.

13. The method as recited in claim 10, wherein said determining further comprises approximating a head shape of said presenter in said captured image and matching a best one of a plurality of pre-defined head shapes with said approximated head shape.

14. The method as recited in claim 13, wherein said determining further comprises defining an eye box bounding a position of where said at least one eye would be on said best one of said plurality of pre-defined shapes.

15. The method as recited in claim 14, wherein said modifying further comprises transmitting, by an interface of said image capture device, a size and position of said eye box to said external projection control processor.

16. The method as recited in claim 10, wherein a computer includes said projection control processor.

17. The method as recited in claim 16, wherein said computer is operatively connected to a projector configured to display said modified projectable image.

18. The method as recited in claim 10, wherein a projector includes said external projection control processor, said projector configured to display said modified projectable image

19. A real-time embedded vision-based eye position detection system, comprising:
a projection control processor; and
an image capture device, said image capture device including:
a camera;
an image processor; and
an interface;
wherein said image processor is configured to:
determine a location of at least one eye of a presenter in a captured image captured by said camera;
and
cause said projection control processor external to said image capture device to modify a corresponding location of a projectable image.

20. The real-time embedded vision-based eye position detection system as recited in claim 19, wherein said image capture device is configured to cause said external projection control processor to change an intensity or color of light in said corresponding location of said projectable image.
